(19) United States
(12) Patent Application Publication
(10) Pub. No.: US 2008/0225005 A1
(43) Pub. Date: Sep. 18, 2008

(54) HAND-HELD MICRO-PROJECTOR PERSONAL COMPUTER AND RELATED COMPONENTS

(76) Inventor: David W. Carroll, Grantsburg, WI (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/029,953

(22) Filed: Feb. 12, 2008

Related U.S. Application Data
(60) Provisional application No. 60/900,832, filed on Feb. 12, 2007.

(51) Int. Cl. G06F 3/02

(52) U.S. Cl. 345/169

(57) ABSTRACT

A mobile personal computer comprising a case sized for handling by a single, adult human hand, a micro-projector system maintained by the case, and a speech recognition system maintained by the case and including a microphone. A microprocessor is maintained within the case and electronically connected to the micro-projector system and the speech recognition system. The microprocessor utilizes a personal computer operating system to perform computing operations. A power source is maintained within the case. Finally, a linear touch pad array adapted to operate as a user interface is assembled to the case such that at least a segment of the linear touch pad array is curved.

### CROSS-REFERENCE TO RELATED APPLICATIONS

This application claims priority under 35 U.S.C. §119(e)(1) to U.S. Provisional Application Ser. No. 60/900,832 filed Feb. 12, 2007 and entitled “Hand-Held Micro-Projector Personal Computer and Related Components,” which was related to U.S. Provisional Application Ser. No. 60/845,867 filed Sep. 20, 2006 and entitled “Mobile, Hand-Held Personal Computer with Micro-Projector, and Systems and Methods for Use Thereof,” the teachings of both of which are incorporated herein by reference.

### BACKGROUND

The present disclosure relates to a hand-held personal computer. More particularly, it relates to a mobile, hand-held personal computer having a micro-projector system and related components. Alternative embodiments incorporate features that enhance functionality of a hand-held personal computer.

Personal computers are virtually a commonplace in today's society. Continued advancements in the technology and manufacturing of various components associated with the personal computer (e.g., processor, memory, display, etc.) have greatly enhanced their operational capabilities. For example, while desktop personal computers continue to be widely used, component technology advancements in combination with development of viable battery power sources have resulted in highly popular laptop personal computers. The transition of consumer preference from desktop personal computers to laptop personal computers is a reflection of an overall demand for portable or mobile electronic devices. That is to say, consumers desire the ability to conveniently transport and use their personal computers at various locations.

While laptop personal computers represent a marked improvement, in terms of mobility, over conventional desktop personal computers, certain consumer desires remain unfulfilled. For example, a laptop personal computer is not truly mobile in that a work surface is required, and the user must employ two hands to operate the laptop personal computer. Further, while flat panel displays used by most laptop personal computers are increasingly able to generate high quality images, a relatively significant amount of power is required, thus limiting the amount of time the laptop personal computer can be operated before recharging of the battery power source is required.

Other electronic devices have been developed that are smaller in size as compared to a conventional laptop personal computer, and thus are inherently more mobile or portable. For example, personal digital assistants (PDA), digital cameras, and mobile phones are widely available. However, these, and other electronic devices are capable of performing only a single, dedicated function, and do not provide and cannot implement a personal computer operating system. That is to say, most available electronic devices operable with one hand are typically not personal computers. Further, most, if not all, of the available portable personal computer devices continue to require both hands of the user and a surface for pen/tablet format to operate.

In light of the above, recent efforts have been made to devise hand-held, personal computing devices. The focus of these efforts, however, has been upon the internal components (e.g., processor, memory, etc.), with little regard to desired user interface. More particularly, hand-held mobile personal computers currently available incorporate the same user interface techniques as conventionally provided with desktop and laptop personal computers (e.g., keyboards (either a physical keyboard or a representation of a keyboard on a display screen), mouse or similar rolling-type device for user-manipulation of a displayed cursor, etc.) except on a reduced scale and/or as a separately-provided component that must be electronically coupled to the personal computer for use. While users are normally familiar with how these conventional interfaces work, the conventional user interfaces are not conducive to hand-held, mobile implementations and/or desired, single-handed use. Simply stated, users in mobile activities use computing devices differently than at a work station. They use the computing devices more times for shorter periods, and have difficulties using both hands when selecting applications, keying letters/numbers/punctuation, and moving through software steps or processes.

Along these same lines, hand-held, mobile personal computers currently under consideration have limited display capabilities. This potential drawback is a function of the conventional design constraints of miniaturizing the personal computer's components. In other words, the conventional thought process is to simply reduce the size of the display screen. While advancements in display screen technology have resulted in reduced-sized, high resolution displays, this approach inherently limits viewing of displayed content to a single user. That is to say, due to the small size of the display screen, only a single person can reasonably view what is being displayed. In many instances, however, a user may desire to have multiple people simultaneously view displayed content (e.g., as part of a group presentation). Under such circumstances, the user must connect the hand-held personal computer to a separate projection device, thereby defeating the intended mobility of the personal computer, or must ask each person in the group to individually look at the display.

In light of the above, a need exists for a hand-held, mobile personal computer having projector display capabilities and capable of single-handed handling and operation.

### SUMMARY

Some aspects of the present disclosure relate to a mobile personal computer comprising a case sized for handling by a single, adult human hand, a micro-projector system maintained by the case, and a speech recognition system maintained by the case and including a microphone. A microprocessor is maintained within the case and electronically connected to the micro-projector system and the speech recognition system. The microprocessor utilizes a personal computer operating system to perform computing operations. A power source is maintained within the case. Finally, a linear touch pad array adapted to operate as a user interface is assembled to the case such that at least a segment of the linear touch pad array is curved.

### BRIEF DESCRIPTION OF THE DRAWINGS

FIG. 1 is a block diagram of a hand-held, mobile personal computer in accordance with principles of the present disclosure;

FIG. 2 is a front perspective view of one embodiment of the mobile personal computer of FIG. 1;

FIG. 3 is a side view of the mobile personal computer of FIG. 2;

FIG. 4 is a front view of the mobile personal computer of FIG. 2

FIG. 5 is a rear perspective view of the mobile personal computer of FIG. 2;

FIGS. 6A-6C represent different applications of a linear touch pad interface of the mobile personnel computer of FIG. 2;

FIGS. 7A and 7B are top views of embodiments of a docking system useful with the mobile personal computer of FIG. 2;

FIGS. 8A and 8B illustrate mounting of the mobile personal computer of FIG. 2 to the docking system of FIG. 7B;

FIG. 9 illustrates the mobile personal computer of FIG. 2 mounted to the docking system of FIG. 7B; and

FIGS. 10A and 10B illustrate the mobile personal computer of FIG. 2 mounted to the docking system of FIG. 7A.

### DETAILED DESCRIPTION

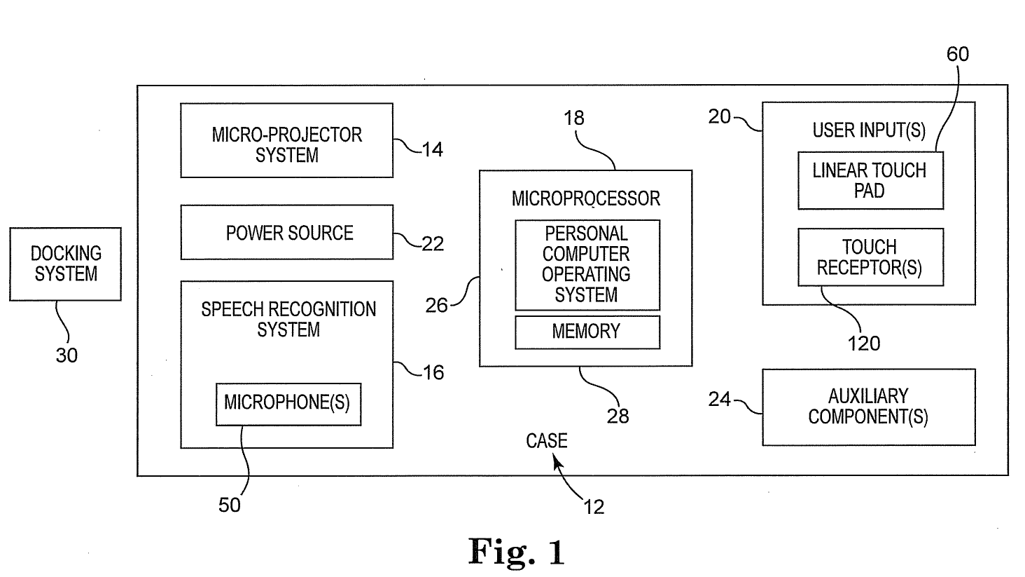

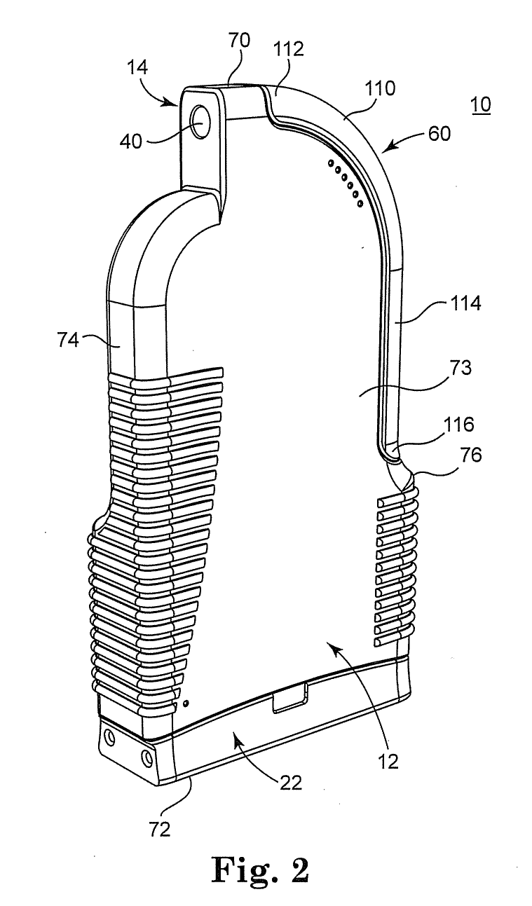

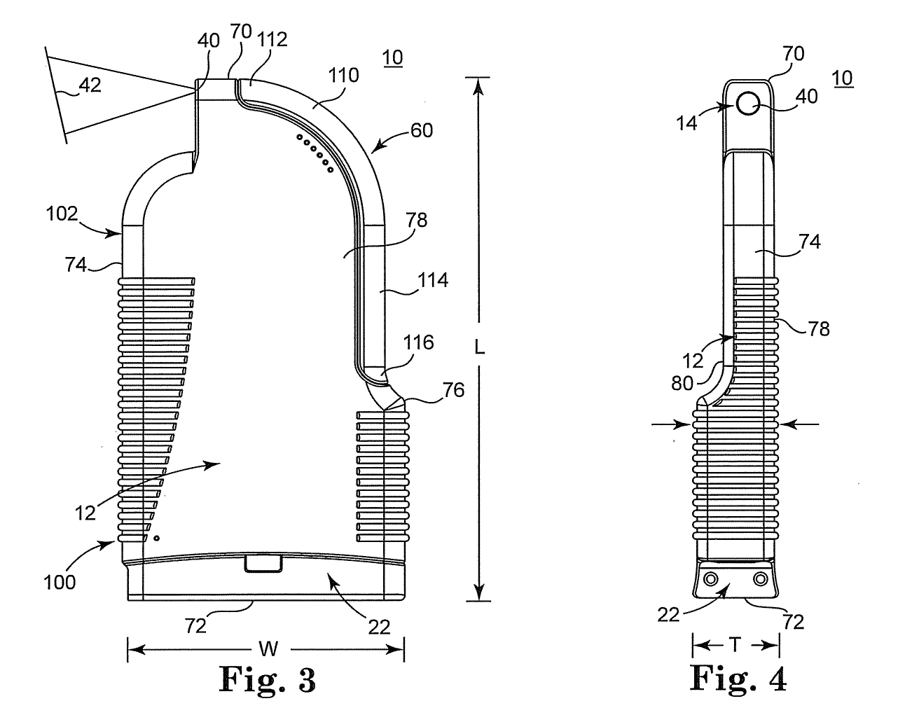

A mobile personal computer 10 in accordance with the present disclosure is shown in the block diagram of FIG. 1. Further, FIGS. 2-5 illustrate one acceptable embodiment of the mobile personal computer 10. The mobile personal computer 10 includes a case 12, a micro-projector system 14, a speech recognition system 16, a microprocessor 18, user inputs 20, and a power source 22. In alternative embodiments, the mobile personal computer 10 can further include one or more auxiliary components 24 as described below. Regardless, the components 14-24 are maintained by the case 12, with the microprocessor 18 performing computing operations and controlling function of the micro-projector system 14, the speech recognition system 16, and the auxiliary component(s) 24 in response to prompts received at the user inputs 20. In this regard, the microprocessor 18 utilizes a personal computer operating system 26 along with a memory 28. Details on the various components are provided below. In general terms, however, the case 12 is sized to be held by a single hand of a user, with the microprocessor 18 rendering the mobile personal computer 10 essentially identical, in a computing sense, to “standard” personal computers (e.g., desktop or laptop personal computers). The micro-projector system 14, the speech recognition system 16, and the user inputs 20 are connected to, and controlled by, the microprocessor 18, and provide highly convenient user interfaces with the mobile personal computer 10. In some embodiments, a re-charging/docking system 30 (described in greater detail below) is provided as an auxiliary device for the mobile personal computer 10. The mobile personal computer 10 can be adapted to operate on either an AC or DC power supply.

Various components of the mobile personal computer 10 can assume different forms, as is known in the art. For example, the micro-projector system 14 can be any system (including appropriate hardware and software) capable of projecting an image or display onto a viewing surface (e.g., a wall) separate from the mobile personal computer 10 itself. Some examples of useful mobile personal computer configurations in which one or more of the features described below can be employed are set forth in U.S. Provisional Application Ser. No. 60/845,867, the teachings of which are incorporated herein by reference. Another embodiment of the mobile personal computer 10 is shown in FIGS. 2-5. In general terms, an output lens 40 (referenced generally) or similar optical component is retained by the case 12, and is provided as part of the micro-projector system 14 (referenced generally in FIG. 2). As represented in phantom in FIG. 5, the micro-projector system 14 projects an image or display 42 onto a viewing surface (unnumbered), with this image having a size that is larger than the output lens 40. That is to say, the micro-projector system 14 is capable of projecting enlarged images from the mobile personal computer 10. Exemplary micro-projector systems 14 include, for example, PicoP micro-projection systems available from Microvision, Inc., of Redmond, Wash. In some embodiments, the micro-projector system 14 is provided as a standalone module that is mounted within the case 12 and electronically connected to the microprocessor 18. In other embodiments, the mobile personal computer 10 can include one or more additional display-type systems (e.g., LED display, microdisplay, etc.). In yet other embodiments, the micro-projector system 14 can be replaced by a conventional display system/screen.

Similarly, the speech recognition system 16 can be any system (including appropriate hardware and software) capable of processing sounds received at one or more microphones 50, such as the microphones 50a, 50b illustrated in FIG. 5. The microphone(s) 50 is preferably a noise-cancelling microphone as known in the art, although other designs are also acceptable. Programming necessary for performing speech recognition operations can be provided as part of the speech recognition system 16, as part of the processor 18, or both. Further, the speech recognition system 16 can be adapted to perform various speech recognition operations, such as speech translation either by the software maintained by the system 16 or via a separate sub-system module (not shown). Exemplary speech recognition systems 16 include, for example, Dragon NaturallySpeaking® from ScanSoft, Inc., of Peabody, Mass., or MicroSoft® Speech Recognition Systems (Beta). Possible positioning of the microphone(s) 50 relative to the case 12 is described in greater detail below.

The microprocessor 18 can also assume a variety of forms known in the art or in the future created including, for example, Intel® Centrino™ and chip and chip sets (e.g., Efficeon™ from Transmeta Corp., of Santa Clara, Calif.). In most basic form, however, the microprocessor 18 is capable of operating the personal computer operating system 26 (e.g., Windows Operating System) that can be provided as part of the microprocessor 18 or be a separate component or module (not shown) electronically connected to the microprocessor 18. In some configurations, the microprocessor 18 utilizes the memory 28 that, in some embodiments, is a flash-type memory.

The user inputs 20 can assume a variety of forms, and are described in greater detail below relative to the case 12 as well as with respect to exemplary modes of operation. In general terms, the user inputs 20 can include a linear touch pad 60. In some embodiments, the mobile personal computer 10 is configured such that none of the user inputs 20 are a keyboard, mouse, or other conventional, moving user interface. In other words, the personal computer 10 is optionally configured to have no external, moving parts.

The power source 22 is, in one embodiment, a lithium-based, rechargeable battery such as a lithium battery, a lithium ion polymer battery, a lithium sulfur battery, etc. Alternatively, a number of other battery configurations are equally acceptable. Regardless, the power source 22 is capable of providing long-term power to the various components of the mobile personal computer 10, and can be re-chargeable as described below.

Where provided, the auxiliary component(s) 24 can assume a number of different forms, several of which are described below. For example, the auxiliary component(s) 24 can include a flat panel secondary display, a wireless communication device (e.g., telephone, radio, etc.), audio speaker(s), docking connection(s), camera(s), motion sensor(s), gravity sensor(s), etc., each or all of which are electronically connected to, and thus interface with, the microprocessor 18. In some embodiments, the secondary display can include two or more display screens that are movably maintained by the case 12 and can be expanded relative to one another (e.g. “fanned” or spread) to provide an enhanced-sized viewing regions, as described, for example, in U.S. application Ser. No. 11/111,399 (filed Apr. 21, 2005) and U.S. Provisional Application Ser. No. 60/848,771 (filed Oct. 2, 2006) the teachings of both of which are incorporated herein by reference.

With the above-described general parameters in mind, in one embodiment, the case 12 is configured to retain all components and is sized for truly mobile use and portability. In this regard, and with reference to FIGS. 2-5, the case 12 defines a top face 70, a bottom face 72, a front face 74, a rear face 76, a first side face 78, and a second side face 80. A relationship of the various components, including the user inputs 20, relative to the faces 70-80 is described in greater detail below. As reflected by the upright orientation of the mobile personal computer 10 in FIGS. 2-5, the case 12 can be described as an elongated body having a length L (i.e., dimension defined between the top face 70 and the bottom face 72), a width W (i.e., dimension defined between the front face 74 and the rear face 76), and a thickness T (i.e., dimension defined between the first and second side faces 78, 80) commensurate with the grip of a normal, adult, human hand. In this regard, the case 12 is sized and shaped such that the image or display 42 is projected from the front face 74, whereas the user input(s) 20 and the microphones 50 are located along the rear face 76. With this construction, one acceptable approach for user handling of the case 12 is by placing the user's palm about one of the side faces 78 or 80, with the user's fingers wrapping about the front face 74 and the user's thumb available to interact with the user input 20. In other words, the orientation of the mobile personal computer 10 in FIGS. 2-5 corresponds with a desired orientation in a user's hand. Further, the case 12 has a streamlined size and shape corresponding with a user's hand, rendering the mobile personal computer 10 highly amenable to insertion and removal to and from a user's pocket.

The case 12 can be formed as an integral body, or as a combination of two (or more) bodies secured to one another, preferably though not necessarily, of a protective, heat dissipating material such as metal. For example, the case 12 can include an external housing and a separate drawer slidably attached to the housing, with the drawer carrying one or more of the components 14-24. With this approach, the external housing can be a molded body incorporating a deflectable feature that automatically contacts heat dispersing component(s) of the electronic devices maintained by the drawer; during use, when the user squeezes (represented by arrows in FIG. 4) or otherwise “actuates” the external housing, the heat dispersing component(s) are initiated. A thermal connector (e.g., a metal screw) can further be provided with the case 12 that extends between a likely pressure point on the case 12, and the internal component(s) for which heat dissipation is needed to draw the two faces 78, 80 together to apply pressure to the drawer. Even further, the drawer can have a wire frame/open construction to more readily facilitate insertion/removal of the replaceable, internal component(s). Along these same lines, the wire frame drawer can serve to establish direct electrical connection between two or more of the internal components (e.g., can electrically connect the power source 22 and the microprocessor 18 upon complete insertion of the drawer). In addition or alternatively, movement of the drawer relative to the housing can be interpreted as an operational prompting activity by the microprocessor 18. The drawer can include a secondary catch device or mechanism that affords a user the ability (e.g., when using a corresponding tool) to more easily extend the drawer from the external housing and expose an internal component to which the user desires access (e.g., wireless SIM card, replaceable battery, memory or mass storage device, etc.). Regardless, the case 12 can define a sealed in enclosure (in combination with embodiments in which the mobile personal computer 10 does not include any external, moving parts), and thus will protect against possible damage when exposed to water. Alternatively, the case 12 can have any other configuration.

The mobile personal computer 10 is preferably configured such that the micro-projector system 14 projects the image 42 from the front face 74 as shown in FIG. 5 and previously described. As reflected in the figures, then, the case 12 is adapted such that when in the upright orientation illustrated, the case 12 naturally maintains the upright position shown when set on a surface 90 (e.g., tabletop). In this upright orientation, then, the case 12 naturally orientates the output lens 40 so as to project the image 42 onto a wall 92. In this regard, the power source 22 (referenced generally in FIGS. 2-5) can be located at or adjacent the bottom face 72 of the case 12, thus serving as a weighted base that serves to stabilize the mobile personal computer 10 in the upright orientation shown. In other words, the power source 22 can be a battery (e.g., brick-shaped or cylindrical body); when located at or adjacent the bottom face 72 of the case 12, the power source/battery 22 effectively lowers a center of gravity of the mobile personal computer 10 (e.g., locates the center of gravity adjacent the bottom face 72 and the weight from the top face 70), making the mobile personal computer 10 more stable in the upright position. Even further, the case 12 can be adapted to define or form first and second sections 100, 102. The first section 100 serves a base, whereas the second section 102 maintains the output lens 40. With these conventions in mind, the case 12 can be constructed such that the second section 102 is rotatably or pivotably mounted to the first section 100. With this configuration, the second section 102 can be moved or pivoted relative to the first section 100, allowing a user to display the image 42 at a wide variety of locations (e.g., a wall, ceiling, etc.) while the first section 100 remains stationary (e.g., on the tabletop surface 90). In addition, where the power source 22 is a battery, in some embodiments, the case 12 can be sized to store the battery 22 mounted back-to-back with a separate memory or mass storage device (e.g., HDD, flash storage, etc.). With this construction, an overall size of the mobile personal computer 10 can be minimized.

As indicated above, the microphone(s) 50, for example the microphones 50a, 50b, are positioned at the rear face 76 as shown in FIG. 5. In some configurations, the microphones 50a, 50b are laterally spaced from one another relative to the rear face 76 by a distance sufficient to permit user handling of the case 12 in a manner that does not result in the user's hand covering either of the microphones 50a, 50b. That is to say, the first microphone 50a is located along the rear face 76 in close proximity to the top face 70, whereas the second microphone 50b is located along the rear face 76 in close proximity to the bottom face 72. With this one acceptable configuration, the microphones 50a, 50b are positioned for properly providing noise-cancelling operations, yet the mobile personal computer 10 is still high amenable to single-handed operation as the microphones 50a, 50b are “exposed” even as the case 12 is held intuitively in the user's hand. Further, in some embodiments, the speech recognition system 16 is adapted to monitor volume levels being received at the microphones 50a, 50b, and alter operation based upon the sensed volume levels. For example, the speech recognition system 16 can be programmed to compare a volume or audio level being received at the microphones 50a, 50b; under circumstances where the difference exceeds a pre-determined value, the speech recognition system 16 will transition to a secondary mode of operation in which the microphone 50a or 50b determined to be receiving a low level of audio input is simply disregarded. Thus, for example, where a user otherwise handling the mobile personal computer 10 positions the case 12 such that the first microphone 50a is in close proximity to the user's mouth, the speech recognition system 16 will determine that a volume level at the first microphone 50a is much greater than a volume level at the second microphone 50b. Under these circumstances, then, the speech recognition system 16 will transition to a secondary mode of operation in which only audio input at the first microphone 50a is considered and acted upon. Alternatively, the speech recognition system 16 can operate in a wide variety of other manners that may or may not include accounting for differences in volume levels at the microphone 50a, 50b.

In some embodiments, the user inputs 20 (FIG. 1) do not include a conventional keyboard interface or any other external, moving parts. This presents a marked improvement over previous designs, and further facilitates truly mobile use (e.g., the mobile personal computer 10 cannot be unintentionally activated or otherwise prompted when otherwise carried within a user's pocket). Alternatively, however, one or more of a conventional keyboard and/or mouse-type interface can be provided, either retained by the case 12, or as a separate component that is electronically linked to the mobile personal computer 10.

As previously described, the user input(s) 20 can include the linear touch pad 60. As shown in FIGS. 2, 3, and 5, the linear touch pad 60 is disposed along the rear face 76 and wraps around along at least a portion of the top face 70 for access by a user's thumb and/or finger(s while being held in the user's hand. A transition of the case 12 from the rear face 76 to the top face 70 is characterized as having a curvilinear shape. The linear touch pad or array 60 corresponds with this curved shape, and thus can be characterized as being a curved linear touch pad or array. From a manufacturing standpoint, this curved configuration renders assembly of the curved linear touch pad 60 to the case 12 easier to achieve in that a well-defined frictional fit between the case 12 and the touch pad 60 is provided. Further, the curved nature of the linear touch pad 60 makes interfacing with the touch pad 60 more intuitive for a user. More particularly, with the but one embodiment of FIGS. 2-5, the curved linear touch pad 60 can be described as including a curved segment 110 extending from a leading end 112 and a linear segment 114 extending to a trailing end 116. The curved segment 110, and in particular the leading end 112, is “above” the linear segment 114/trailing end 116 when the mobile personal computer 10 is in the upright orientation of FIGS. 2-5. Thus, during normal handling, the user will readily perceive a “top end” of the touch pad 60 (i.e., the leading end 112), and a “bottom end” (i.e., the trailing end 116). Various user interface techniques described below may require a user to “remember” which “end” of the linear touch pad 60 corresponds with a particular stream of operational effects. Under these circumstances, by positioning the leading end 112 above and away from the trailing end 116, the user will intuitively “remember” which end corresponds with which operational function.

With the one embodiment of FIGS. 2-5, the leading end 112 of the linear touch pad 60 terminates at a point spaced from the output lens 40. In other embodiments, however, the linear touch pad/array 60 can extend across the output lens 40, with the linear touch pad/array 60 further including a hole or similar aperture through which images from the output lens 40 can be projected. With this approach, an increased, available surface area of the linear touch pad/array 60 is provided. Along these same lines, the output lens 40 (or other component associated with the micro-projector system 14) can be incorporated directly into the linear touch pad/array 60. Similarly, the linear touch pad/array 60 is formed in association with the microphone 50a in some embodiments. For example, the linear touchpad/array 60 can form a hole 118 at which the microphone 50a is located. With this approach, the microphone 50a will be at a desired level for best receiving audio/sound inputs from a user during use. Even further, the linear touch pad/array 60 can be formed to include an integrated antennae for use by other components (e.g., wireless interface) provided with the mobile personal computer 10. Other components can further be accommodated by, or integrally formed with, the linear touch pad/array 60. For example, the touch pad 60 can include an additional hole or feature that facilitates mounting (or direct integration) of a finger identification device or other biometrics identification device as is known in the art. Also, the linear touch pad/array 60 can be employed as a surface for mounting, or can integrally form, a vibrating surface of an audio speaker (provided as one of the auxiliary components 24 (FIG. 1) of the mobile personal computer 10).

While the linear touch pad 60 has been described as being attached to the case 12, other configurations are also acceptable. For example, a portion of the linear touch pad/array 60 can be removably secured to the case 12. One such example includes the curved segment 110 being releasably secured to the case 12, whereas the linear segment 114 is more permanently attached to the case 12. With this approach, the curved segment 112 (or other portion of the linear touch pad/array 60) can be flexed away from the case 12, with the mobile personal computer 10 being adapted to perform a dedicated action (e.g., operate in a pre-determined mode) when the curved segment 112 is flexed away from the case 12 (e.g., the mobile personal computer 10 can include a sensor or similar device that “senses” a location of the curved segment 112 relative to the case 12). Further, and commensurate with the above description of one embodiment in which the case 12 includes an external housing and a drawer slidably attached thereto, the linear touch pad/array 60 can serve as and/or be included with the drawer portion, and thus is removable relative to the external housing. Similarly, the mobile personal computer 10 can be configured such that the linear touch pad/array 60 has a connector (e.g., electrical flex connector) operable to accept or “complete” an electrical connection between the linear touch pad/array 60 and the microprocessor 18 when the drawer with mounted electronics is fully inserted into the external housing. With this approach, the linear touch pad/array 60 is automatically activated upon full insertion of the drawer, and electrically completes connection to other components associated with and/or carried by the linear touch pad/array 60 (e.g., the micro-projector system 14, lights, antennae, fingerprint reader, etc.).

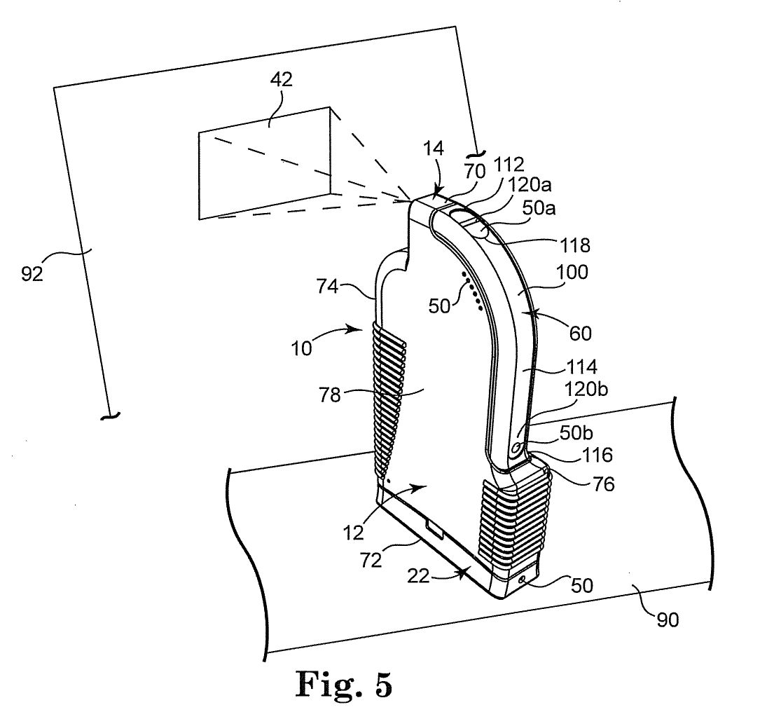

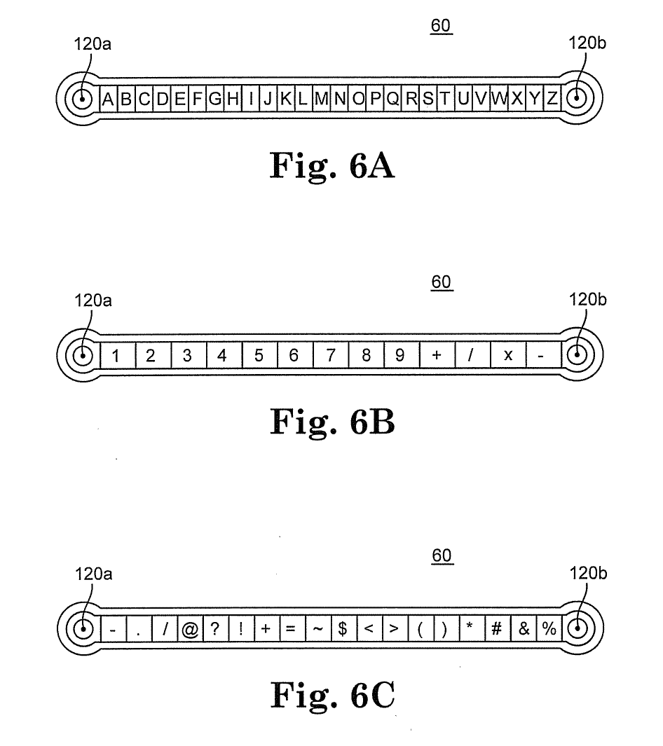

Regardless of an exact configuration, in accordance with some embodiments, the linear touch pad 60 includes a pressure sensitive membrane strip (not shown) that effectively is divided into or defines a number of touch regions arranged side-by-side (or operated upon or in response to, the microprocessor 18). The touch pad 60 is shown in an “uncurved” state for ease of explanation in FIGS. 6A-6C. For example, as shown in FIG. 6A, the linear touch pad 60 can be configured to designated letters as assigned to discrete linear locations thereon. When the user's finger “taps” on a particular location along the linear touch pad 60, the corresponding letter will appear or by highlighted on the display or image generated by the mobile personal computer 10 (e.g., the projected image generated by the micro-projector system 14). Alternatively, the linear touch pad 60 can be operated by the microprocessor 18 (FIG. 1) to define or represent a series of discrete numbers (FIG. 6B), punctuation (FIGS. 6C), characters, symbols, etc. By scrolling or sliding the user's finger along the linear touch pad 60, the letter (or number or punctuation) corresponding to the finger's location relative to the touch pad 60 will be “highlighted” on the projected display or image. When the letter (or number or punctuation) desired by the user is highlighted in the display, the user simply “taps” the linear touch pad 60 to select that letter (or number or character). Along these same lines, the linear touch pad 60 can be used to control other operations (e.g., where the personal computer 10 includes a camera, the linear touch pad 60 can effectuate a zooming command via the user sliding his/her finger along the linear touch pad 60).

Returning to FIGS. 2-5, the linear touch pad 60 has a wide variety of applications, and is particularly useful with speech recognition. In general terms, speech recognition entails a user speaking into the microphone(s) 50, with words being recognized appearing on the display or image generated by the device 10. With this technique, the user can readily confirm that the system is recognizing the word(s) intended by the user. While current speech recognition software is quite proficient at recognizing most words spoken by a user (following appropriate “training”), in many instances, errors can occur. One approach for addressing this possibility is for a series of words to appear on the generated display or image in order of probability of “match” to the word spoken by the user (e.g., the user may say “two” and the words “to,” “too,” and “two” will appear on the generated or projected display or image). The linear touch pad 60 affords the user the ability to quickly select the desired term by assigning each of the lists of words to a location on the linear touch pad 60. The user can, for example, slide his/her finger along the linear touch pad 60 until the desired word is highlighted on the generated display or image and then “double tap” the linear touch pad 60 to “select” the word.

Regardless of the particular application for which the linear touch pad 60 is employed, in some embodiments, the user inputs 20 (FIG. 1) can further include one or more touch receptors 120 (FIG. 1), for example, 120a, 120b illustrated in FIGS. 6A-6C at opposing ends of the linear touch pad 60 (or elsewhere along the case 12 (FIG. 1)). In general terms, the touch receptors 120 can assume a variety of forms and in some embodiments are connective or conductive elements that can effectively “sense” when a user's finger/thumb is in contact therewith (via, for example, a sensed change in conductivity or resistivity). Alternatively, the touch receptor(s) 120 can assume a more conventional form, such as a key or button. Further, the touch receptors 120 can include a backlight for illuminating a corresponding button component. Regardless, relative to the linear touch pad 60 of FIGS. 6A-6C, the first and second touch receptors 120a, 120b can be employed by the user to alter the intended application of the linear touch pad 60. For example, the microprocessor 18 can be programmed such that when one or both of the touch receptors 120a, 120b are contacted or touched by a user's finger/thumb, the linear touch pad 60 operation is changed from the alphabetic designations of FIG. 6A to the numeric designation of FIG. 6B. A wide variety of other touch patterns can be employed with the touch receptor 120a, 120b relative to operation of the mobile personal computer 10 via the linear touch pad 60. For example, the linear touch pad 60 can be “activated” and “deactivated” when a certain one or both of the touch receptors 120a, 120b are touched (e.g., on/off and/or “deep sleep”); can switch between modes of operation in response to a selected one or both of the touch receptors 120a, 120b being touched; etc. Along these same lines, additional operational commands can be effectuated via the touch receptor 120a, 120b in response to two or more consecutive touches of one or both of the touch receptors 120a and/or 120b; in response to one or both of the touch receptors 120a, 120b being contacted for a certain time period; etc. Other touch receptors are optionally further provided, as described, for example, in U.S. Provisional Application Ser. No. 60/845,867.

In other embodiments, the auxiliary components 24 (FIG. 1) can include one or more components that facilitate desired user interface with a display or image projected from the mobile personal computer 10. As a point of reference, a projected display or image (via the micro-projector system 14) can be viewable and “in focus” on a multitude of surfaces, including curved surfaces. The micro-projector system 14 can be configured such that even as the case 12 is moved toward or away from the viewing surface, the displayed or projected image remains in focus. In this regard, while the case 12 can be laid on a stable surface (e.g., table top) while an image is displayed/projected, in other instances, the user will hold the case 12 in his/her hand while displaying/projecting the image. Under these circumstances, the micro-projector system 14 can further include an anti-vibration component (not shown) that maintains a position of the displayed image relative to the display surface even with slight movements of the case 12 (for example, where the user's hand slightly shakes). For example, a gimble-based component can be included as part of, or connected to, the micro-projector system 14 that off-sets slight movements of the case 12. These or other image stabilization devices can be provided with the mobile personal computer 10 to facilitate single-handed user interface with the projected image as described below. As a point of reference, the stabilization device can operate based upon motion, gravity, and/or distance. With any or all of these techniques, a fixed point can be established relative to the projected image and/or a moving point can be established relative to a fixed, projected image. For example, the microprocessor 18 can be programmed to establish a fixed point relative to the displayed or projected image, and in particular a “fixed cursor” displayed “on” the projected image.

In one embodiment, the fixed cursor represents the fixed point. With movement of the case 12, the displayed/projected image will move relative to the displayed/projected fixed cursor. Once a desired portion or segment of the displayed/projected image is aligned with the fixed cursor, one or more of the touch receptors 120 can be contacted by the user to prompt operation based upon the item highlighted by the fixed cursor. In this regard, the microprocessor 18 electronically monitors and maintains a relationship between a virtual representation of the fixed cursor relative to a virtual representation of an item being displayed on the projected image. As portions of the displayed image are browsed or “moved” on the projected fixed cursor, the data representative of the particular content currently displayed/projected “beneath” the displayed/projected fixed cursor is electronically managed and continuously “known” by the microprocessor 18. Thus, for example, the user can initiate a desired action by moving desired content “under” the fixed cursor and interfacing with one or more of the touch receptors 62, such as linking to an internet website address identified by the fixed cursor. Additional details relating to the fixed cursor interface are provided in U.S. application Ser. No. 11/112,308, filed Apr. 21, 2005 and entitled “Hand-Held Display Device and Method of Controlling Displayed Content,” the teachings of which are incorporated herein by reference.

Alternatively, the displayed/projected image user interface can be accomplished by establishing a fixed position of the displayed/projected image relative to the viewing surface, along with a displayed/projected cursor that moves relative to the fixed image with movement of the case 12. In other words, using known image stabilization techniques, the display/projected image is caused to be “held” in a fixed position on the viewing surface even with slight movement of the case 12 (e.g., in response to an appropriate prompt at one or more of the touch receptors 120). In addition, the microprocessor 18 causes a moveable cursor to be displayed/projected on the fixed image. The cursor moves with movement of the case 12, while the displayed/projected image remains fixed. With this approach, then, the user can move the displayed cursor to a desired location on the displayed image, and then interface with one or more of the touch receptors 120 to prompt operation of the microprocessor 18 based upon the image content “below” the cursor position.

Though the user/image interface described above is useful, it is not a required feature of the mobile personal computer of the present disclosure. Where provided, however, the user/image interface potentially eliminates the need for a dedicated mouse device, provides larger cursor positioning interface ratio to the user for easier operation (e.g., the ratio of system to cursor is more accurate and less sensitive than a standard mouse or touch system), and can operate “in-ratio” to the size of the projected image.

In other embodiments, the mobile personal computer 10 further includes a sleeve (not shown) removably disposed over the case 12. While the case 12 beneficially serves as an excellent heat distribution/dissipation body (in that the case 12 is preferably, though not necessarily, made of metal), this may cause handling discomfort. The sleeve serves to protect the user's hand from excessive heat, and can include opening(s) commensurate with the various components carried by the case 12 (e.g., one or more of the microphones 50, the output lens 40, the linear touch pad 60, the touch receptor(s) 120, etc.). The sleeve can be a plastic-based material, and can form a series of “bumps” that lift the sleeve off of the metal case 12. Further, the sleeve can be removed from the case 12 and replaced with another sleeve having a stylized appearance desired by the particular user.

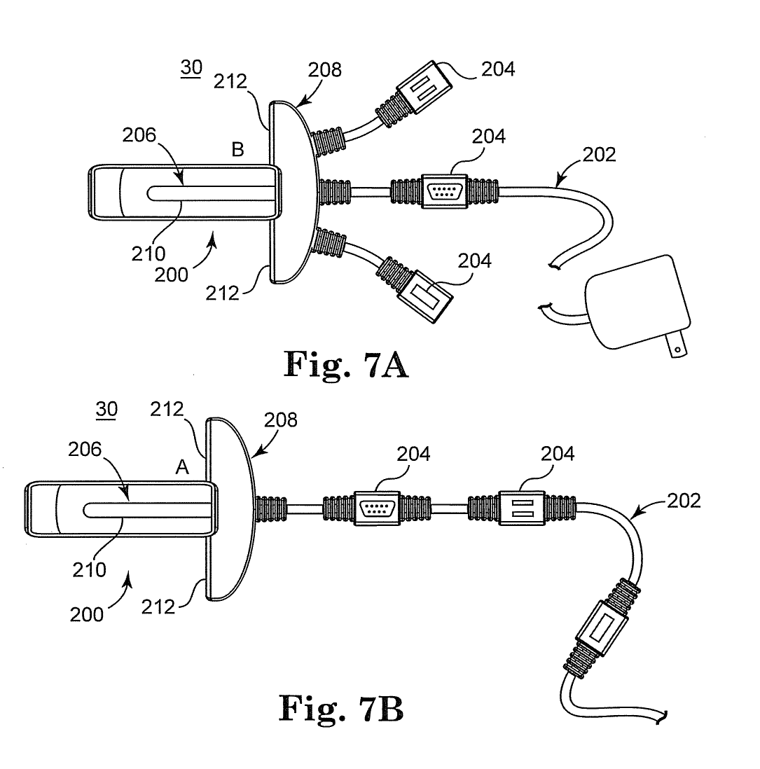

In some embodiments, the mobile personal computer 10 is adapted for use with the re-charging/docking system 30 otherwise referenced generally in FIG. 1. One embodiment of the docking system 30 is shown in FIG. 7A. In general terms, the docking system 30 includes a base 200, a power cord 202, and optionally one or more connector plugs 204. The base 200 includes a connector strip 206 and a support 208 that combine to define a T-like shape. The connector strip 206 is sized to releasably interface with the mobile personal computer 10 as described below, and includes an electrical receptacle 210. The electrical receptacle 210 maintains various electrically conductive elements (e.g., connector pins) adapted to interface with the mobile personal computer 10 as described below. Wiring (not shown) extends from the electrical connectors to a corresponding one of the power cord 202 or connector plugs 204. The support 208 is an elongated body effectively defining opposing wings 212 relative to the strip 210. The power cord 202 as well as the connector plugs 204 extend from the support 208 opposite the strip 206. Another embodiment docking system 30′ is shown in FIG. 7B.

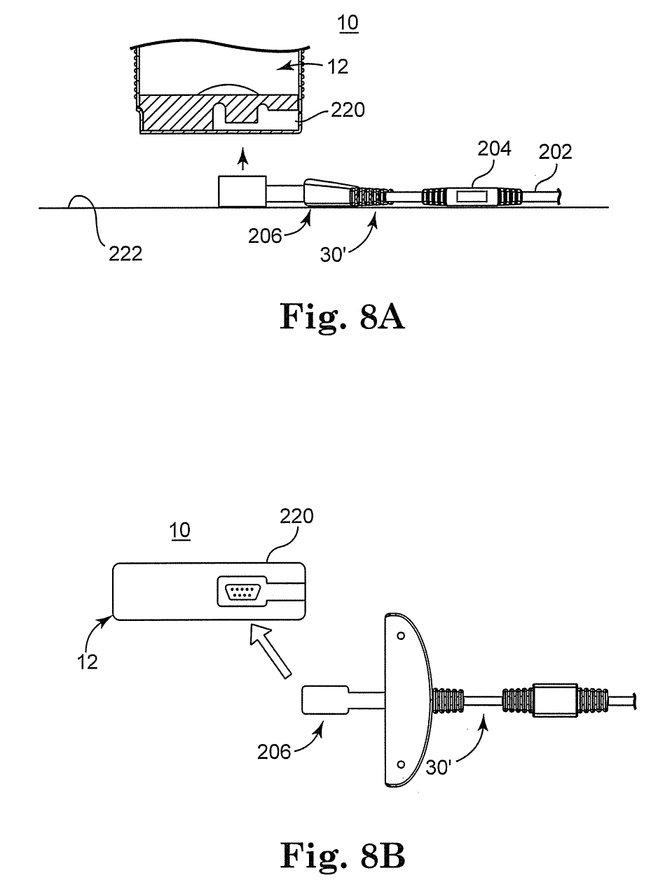

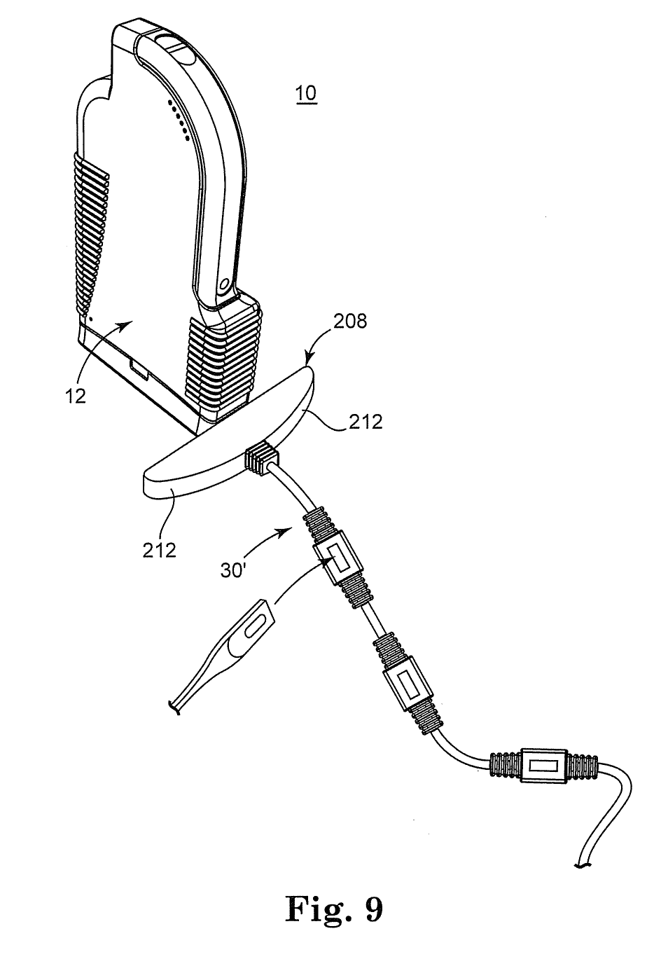

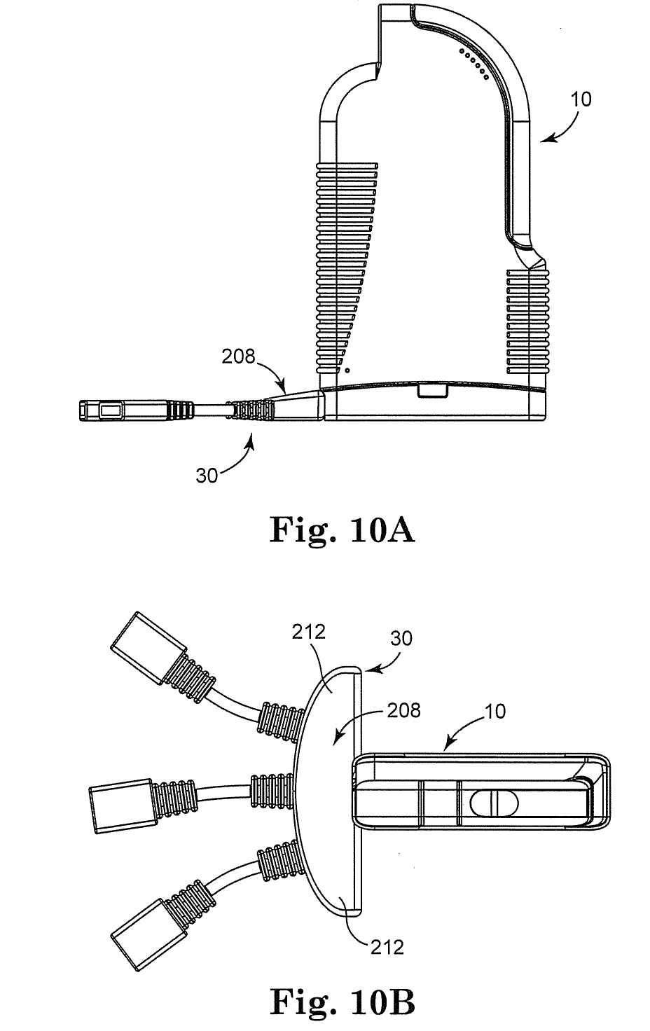

As shown in FIGS. 8A and 8B, in some embodiments, the case 12 of the mobile personal computer 10 is adapted to dock with the strip 206, and in particular the receptacle 210, and includes a recess 220 sized to receive the strip 206. Thus, where the strip 206 is laid on a surface 222, the mobile personal computer 10 can be releasably mounted onto the strip 206 by simply orienting the case 12 in an appropriate manner and then pressing the case 12 downwardly onto the strip 206. Once mounted to the strip 206, an electrical connection is established between the electrical connectors and corresponding components of the mobile personal computer 10. For example, an electrical connection is established between the power cord 202 and the power source 22 (e.g., a re-chargeable battery). Similar, electrically communicative connections can be established between one or more other components of the mobile personal computer 10 and one or more of the connector plugs 204 (e.g., the microprocessor 18 can be communicatably linked to a separate component otherwise connected to the corresponding plug 204). Regardless, in the upright configuration of FIGS. 9-10B, when the mobile personal computer 10 is mounted to the strip 206, the support 208 serves to stabilize the mobile personal computer 10 in the upright orientation. More particularly, the wings 212 resist “tipping” of the mobile personal computer 10. The connector plugs/cables 204 are preferably short, flexible connectors mounted to the support 208 so as to naturally lay on the surface 222. In other embodiments, the docking system 30 can be configured such that the base 200 is adapted to selectively receive the power cord 202 (e.g., the base 200 can define one or more slots (not shown) within which the power cord 202 can be coiled). With this approach, the docking system 30 can be held in a compact form, convenient for placement in a user's pocket.

Although the present disclosure has been described with reference to preferred embodiments, workers skilled in the art will recognize that changes can be made in form and detail without departing from the spirit and scope of the present disclosure. Various additional features can be incorporated such as integrated wireless connectivity and internet access, USB connector(s), music device(s), Google Write software, and SKYPE communications, etc. Regardless, the mobile personal computer is easy to use, and provides long-term battery life via instant on/off powering.

What is claimed is:

1. A mobile personal computer comprising:
a case sized for handling by a single, adult, human hand;
a micro-projector system maintained by the case;
a speech recognition system maintained by the case and including a microphone;
a microprocessor maintained within the case and electronically connected to the micro-projector system and the speech recognition system, the microprocessor utilizing a personal computer operating system to perform computing operations;
a power source maintained within the case; and
a linear touch pad array adapted to operate as a user interface and assembled to the case such that at least a segment of the linear touch pad array is curved.

2. The mobile personal computer of claim 1, wherein the linear touch pad array is a curved linear touch pad array.

3. The mobile personal computer of claim 1, wherein the linear touch pad array includes a curved segment and a linear segment.

4. The mobile personal computer of claim 3, wherein in an upright state, the case defines a top face, a bottom face, a front face, a rear face, and opposing first and second side faces, and further wherein at least a portion of the curved segment is disposed along the top face and at least a portion of the linear segment is disposed along the rear face.

5. The mobile personal computer of claim 4, wherein a shape of the linear touch pad array corresponds with a shape defined by the top face and the rear face.

6. The mobile personal computer of claim 4, wherein the microprocessor is programmed to operate the linear touch pad array as providing a series of consecutive touch zones indicative of sequential input operators, including operating a first terminal end of the curved segment as a first sequential operator and an opposing, second terminal end of the linear segment as a final sequential operator.

7. The mobile personal computer of claim 4, wherein the micro-projector system includes an output lens through which images are projected, and further wherein the mobile personal computer is configured such that the output lens projects images from the front face of the case.

8. The mobile personal computer of claim 7, wherein the lens is positioned in close proximity to the top face.

9. The mobile personal computer of claim 4, further comprising first and second touch receptors located at opposite ends of the linear touch pad array, respectively, and electronically connected to the microprocessor, and further wherein the microprocessor is programmed to perform a predetermined operational step in response to a user interfacing with the touch receptors.

10. The mobile personal computer of claim 4, wherein the speech recognition system includes a first microphone positioned proximate the bottom face and a second microphone positioned proximate the top face.

11. The mobile personal computer of claim 10, wherein the first and second microphones are positioned to not be covered by a user's hand holding the case.

12. The mobile personal computer of claim 10, wherein the first microphone is positioned adjacent a first end of the linear touch pad array and the second microphone is positioned adjacent an opposite, second end of the linear touch pad array.

13. The mobile personal computer of claim 10, wherein the speech recognition system is programmed to perform noise canceling operations upon audio inputted at the first and second microphones.

14. The mobile personal computer of claim 10, wherein the speech recognition module is programmed to operate based upon a difference in audio input decibel levels at the first and second microphones.

15. The mobile personal computer of claim 1, wherein in an upright state, the case defines a length greater than a width and a width greater than a thickness, and further wherein at least a portion of an exterior surface of the case is curved.

16. The mobile personal computer of claim 15, wherein in the upright state, the case defines a top face, a bottom face, a front face, a rear face, and opposing first and second side faces, and further wherein the power source is maintained proximate the bottom face.

17. The mobile personal computer of claim 16, wherein the micro-projector system includes an output lens through which images are projected, the mobile personal computer configured such that the output lens projects images from the front face, proximate the top face.

18. The mobile personal computer of claim 16, wherein the bottom face forms a recess sized to slidably receive a strip of a docking system.

19. The mobile personal computer of claim 1, wherein the microprocessor is programmed to establish and display a fixed cursor on images projected from the micro-projection system.

20. A mobile personal computer system comprising:
a mobile personal computer including:
a case sized for handling by a single, adult, human hand,
a micro-projector system maintained by the case,
a speech recognition system maintained by the case and including a microphone,
a microprocessor maintained within the case and electronically connected to the micro-projector system and the speech recognition system, the microprocessor utilizing a personal computer operating system to perform computing operations,
a power source maintained within the case,
a linear touch pad array adapted to operate as a user interface and assembled to the case such that at least a segment of the linear touch pad array is curved; and
a docking station including:
a base including a connector strip and a support, the connector strip adapted to releasably receive the case and providing an electrical receptacle for electrically interfacing with the power source, and the support extending from the connector strip to form a T-like shape,
a power cord extending from the connector strip and electrically coupled to the electrical receptacle.
